(19) United States
(12) Patent Application Publication
(10) Pub. No.: US 2025/0244762 A1
(43) Pub. Date: Jul. 31, 2025

(54) ARCHITECTURE AND METHOD FOR AR TAG DETECTION AND LOCALIZATION FOR MOBILE ROBOTS

(71) Applicant: Bear Robotics, Inc., Redwood City, CA (US)

(72) Inventors: Qingran Lin, Foster City, CA (US); Zheng Wang, Belmont, CA (US)

(73) Assignee: Bear Robotics, Inc., Redwood City, CA (US)

(21) Appl. No.: 19/042,282

(22) Filed: Jan. 31, 2025

Related U.S. Application Data
(60) Provisional application No. 63/627,108, filed on Jan. 31, 2024.

(51) Int. Cl. G05D 1/244; G05D 101/00

(52) U.S. Cl. CPC G05D 1/2446; G05D 2101/22

(57) ABSTRACT

A robot includes a controller programmed to: when a single tag is detected in an image captured by an imaging sensor, apply a first tag detection algorithm to the image to obtain pose data of the single tag; when two or more tags are detected in the image, apply a second tag detection algorithm to the image to obtain pose data of the two or more tags; obtain pose data of the single tag in a map frame or pose data of the two or more tags in the map frame; determine pose data of the robot in the map frame based on a comparison of the pose data of the tag in the image and the pose data of the tag in the map frame; and operate one or more motors to autonomously navigate the robot based on the pose data of the robot in the map frame.

### CROSS-REFERENCE TO RELATED APPLICATIONS

This application claims the benefit of U.S. Provisional Application No. 63/627,108 filed on Jan. 31, 2024, the entire contents of which are herein incorporated by reference.

### TECHNICAL FIELD

The present disclosure generally relates to systems and methods for detecting AR tags and localizing a mobile robot in an indoor environment based on the detected AR tags.

### BACKGROUND

While a mobile robot is moving in an indoor environment, due to sensor system noise, sensor failure, or challenging environment with no features or highly symmetric environment, the mobile robot may have mislocalization issues. The mislocalization may cause the failure of the mission of the mobile robot and require extra human intervention to relocalize the mobile robot. Thus, the mobile robot needs to correct its pose in real time to prevent mislocalization when the mobile robot is moving in the indoor environment.

Accordingly, a need exists for a robot that automatically corrects its pose in real time to address mislocalization issues.

### SUMMARY

In one aspect, a robot includes an imaging sensor, one or more motors, and a controller. The controller is programmed to: during a navigation mode: determine whether two or more tags are detected in an image captured by the imaging sensor; in response to determining that a single tag is detected in the image, apply a first tag detection algorithm to the image to obtain pose data of the single tag in the image; in response to determining that two or more tags are detected in the image, apply a second tag detection algorithm to the image to obtain pose data of the two or more tags in the image; obtain pose data of the single tag in a map frame or pose data of the two or more tags in the map frame; determine pose data of the robot in the map frame based on a comparison of the pose data of the single tag in the image and the pose data of the tag in the map frame, or determine pose data of the robot in the map frame based on a comparison of the pose data of the two or more tags in the image and the pose data of the two or more tags in the map frame; and operate the one or more motors to autonomously navigate the robot based on the pose data of the robot in the map frame.

In another aspect, a method for controlling a robot is provided. The method includes during a navigation mode: determining whether two or more tags are detected in an image captured by an imaging sensor; in response to determining that a single tag is detected in the image, applying a first tag detection algorithm to the image to obtain pose data of the single tag in the image; in response to determining that two or more tags are detected in the image, applying a second tag detection algorithm to the image to obtain pose data of the two or more tags in the image; obtaining pose data of the single tag in a map frame or pose data of the two or more tags in the map frame; determining pose data of the robot in the map frame based on a comparison of the pose data of the single tag in the image and the pose data of the tag in the map frame, or determining pose data of the robot in the map frame based on a comparison of the pose data of the two or more tags in the image and the pose data of the two or more tags in the map frame; and operating one or more motors of the robot to autonomously navigate the robot based on the pose data of the robot in the map frame.

In yet another aspect, provided is a non-transitory computer readable medium storing instructions, when executed by a processor, that instruct a robot to perform: during a navigation mode: determining whether two or more tags are detected in an image captured by an imaging sensor; in response to determining that a single tag is detected in the image, applying a first tag detection algorithm to the image to obtain pose data of the single tag in the image; in response to determining that two or more tags are detected in the image, applying a second tag detection algorithm to the image to obtain pose data of the two or more tags in the image; obtaining pose data of the single tag in a map frame or pose data of the two or more tags in the map frame; determining pose data of the robot in the map frame based on a comparison of the pose data of the single tag in the image and the pose data of the tag in the map frame, or determining pose data of the robot in the map frame based on a comparison of the pose data of the two or more tags in the image and the pose data of the two or more tags in the map frame; and operating one or more motors of the robot to autonomously navigate the robot based on the pose data of the robot in the map frame.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 depicts an overall system including a mobile robot communicating with a cloud server via a communication network, according to one or more embodiments described and shown herein;

FIG. 2 depicts the block diagram of the overall system, according to one or more embodiments described and shown herein;

FIG. 3 depicts a flowchart of the mapping process of AR tags during a mapping mode, according to one or more embodiments shown and described herein;

FIG. 4 depicts a flowchart of the AR tag detection and localization process during a navigation mode, according to one or more embodiments shown and described herein;

FIG. 5 depicts a scenario when the mobile robot localizes itself by detecting and analyzing coplanar tags, according to one or more embodiments shown and described herein;

FIG. 6 depicts a scenario when the mobile robot localizes itself by detecting and analyzing tags on different planes, according to one or more embodiments shown and described herein;

FIG. 7 depicts a flow chart of depth fusion tag detection, according to one or more embodiments shown and described herein; and

FIG. 8 depicts a flow chart of tag bundle detection, according to one or more embodiments shown and described herein.

### DETAILED DESCRIPTION

The embodiments described herein are directed to a mobile robot that detects AR tags and localizes itself based on the analysis of the detected tags. An AR tag, such as AprilTag, ArUco, or ARTag, functions as a fiducial system supporting 3D registration and pose tracking in augmented reality. AR tags allow for video tracking capabilities that calculate a camera's position and orientation relative to physical markers in real time. AR tag technology is extensively utilized in the robotics industry. Despite its prevalence, the direct use of the pose data of the detected AR tags for robot localization is hindered by ambiguity issues. This limits the usage of AR tags to either on the floors or on the ceilings. This present disclosure introduces an architecture designed to address these challenges, ensuring flexible placement of AR tags and reliable position determination for mobile robots as they navigate in an indoor environment.

The present disclosure provides a distinctive structure for a mobile robot to calculate its location within an indoor environment using AR tags. The present system operates independently in two modes: a mapping mode and a navigation mode. During the mapping mode, the present system employs a depth fusion method that utilizes RGB data and depth data of a captured image to compute pose data of detected tags in a map or a map frame. During the navigation mode, the mobile robot is localized either through a single AR tag using a depth fusion detection algorithm or through multiple AR tags using a tag bundle detection algorithm.

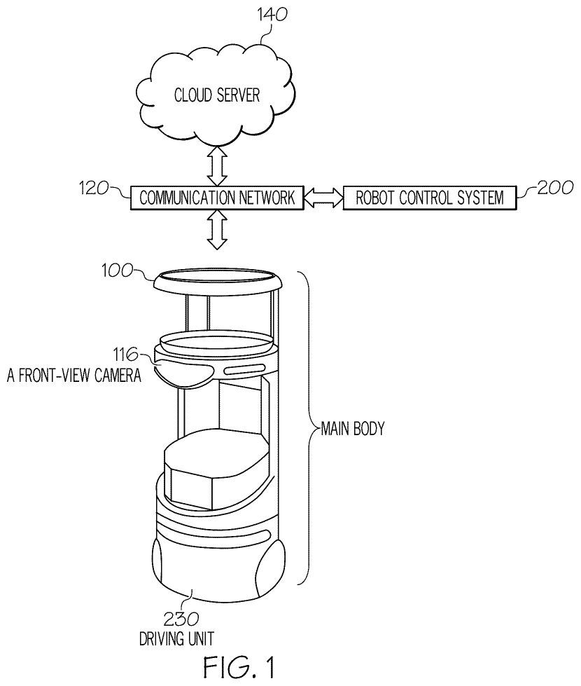

FIG. 1 depicts an overall system including a mobile robot communicating with a cloud server via a communication network, according to one or more embodiments described and shown herein. In embodiments, the system includes a mobile robot 100, a communication network 120, a cloud server 140, and a robot control system 200. The mobile robot 100 may upload map data to the cloud server 140 via the communication network 120 and download map data from the cloud server 140 via the communication network 120. The map data may include a map for an indoor environment along with the pose data of tags located in the indoor environment. The mobile robot 100 may utilize the map data when navigating in the indoor environment. The robot control system 200 may be a local computing device or an edge device, e.g., a computer located at a store, that communicates with the mobile robot 100 and controls movement of the mobile robot 100 locally.

The main body of the mobile robot 100 may include a front-view camera 116 and a driving unit 230. The front-view camera 116 may be a RGBD camera. The RGBD camera is a type of depth camera that provides both depth (D) and color (RGB) data as the output in real-time. The driving unit 230 may move the mobile robot 100 around.

The mobile robot 100 may perform predetermined functions or assigned tasks (e.g., serving food and retrieving containers) through communication with the robot control system 200, and may include a support configured to support at least one object. The mobile robot 100 may include at least one of a module (e.g., a grab or a robotic arm module) for loading and unloading an object (e.g., a food tray), an imaging module (e.g., a visible light camera or an infrared camera) for acquiring images of surroundings, a scanner module (e.g., a LIDAR sensor) for acquiring information on obstacles, a sound acquisition module (e.g., a microphone) for acquiring sounds of surroundings, an illuminance acquisition module (e.g., an illuminance sensor) for sensing brightness of surroundings, a speaker module for providing sound information, a display module (e.g., LCD) for providing visual information such as text information, a light emitting module (e.g., LED) for providing visual information such as color information, and a drive module (e.g., a motor) for moving the mobile robot 100.

For example, the mobile robot 100 may have characteristics or functions similar to those of at least one of a serving robot, a guide robot, a transport robot, a cleaning robot, a medical robot, an entertainment robot, a pet robot, and an unmanned flying robot. Meanwhile, supporting of an object herein should be interpreted as encompassing supporting of a container for containing an object such as food, a means where the container may be placed (e.g., a tray), or the like.

Meanwhile, according to one embodiment of the present disclosure, the mobile robot 100 may include an application (not shown) for controlling the mobile robot 100. The application may be downloaded from the robot control system 200 or an external application distribution server, such as the cloud server 140. The application may be stored in the memory of the mobile robot 100 such as the one or more memory modules 204 in FIG. 1B. Here, at least a part of the application may be replaced with a hardware device or a firmware device that may perform a substantially equal or equivalent function, as necessary.

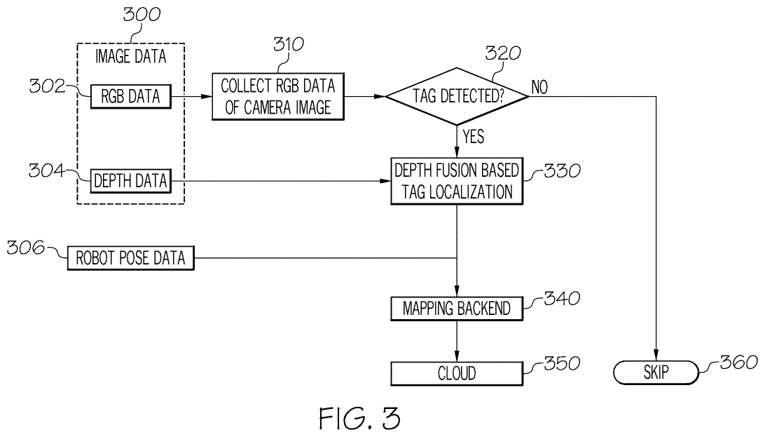

The mobile robot 100 may operate in two major operation modes: a mapping mode and a navigation mode. During the mapping mode, the mobile robot 100 builds a map of the environment and collect AR tag data including tag ID and tag positions, and eventually uploads the collected data to the cloud server 140. The details of the mapping mode will be described below with reference to FIG. 3.

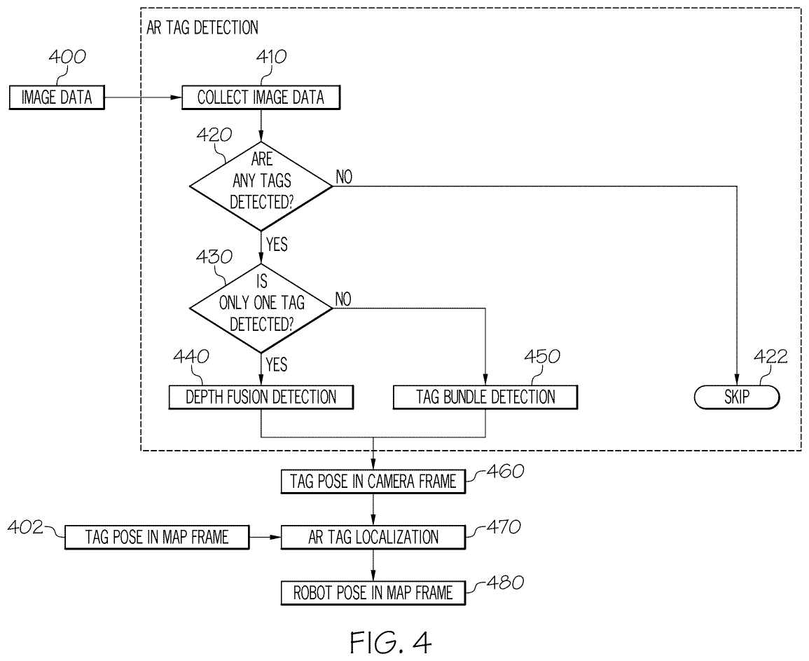

During the navigation mode, the mobile robot 100 downloads the map data and AR tag information from the cloud server 140. Based on the downloaded data, the mobile robot 100 may navigate and perform delivery tasks. The details of the mapping mode will be described below with reference to FIG. 4-8.

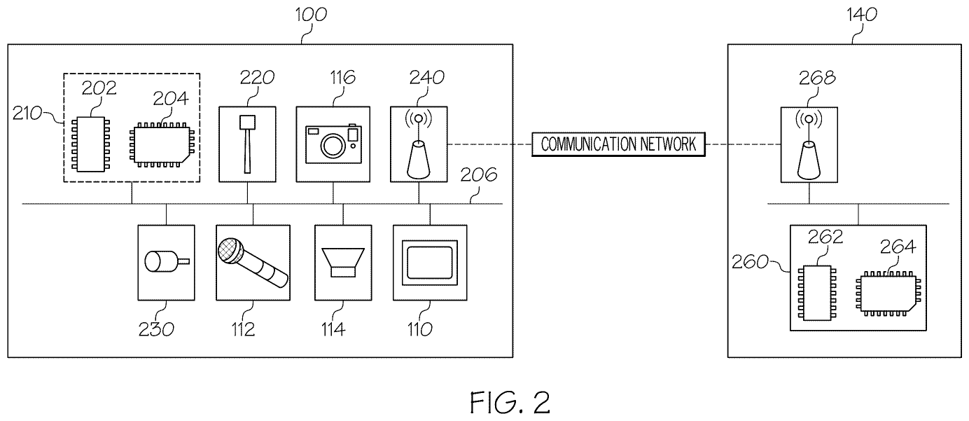

Referring now to FIG. 2, various internal components of the mobile robot 100 and the cloud server 104 are illustrated. The mobile robot 100 may include a controller 210 that includes one or more processors 202 and one or more memory modules 204, a satellite antenna 220, a driving unit 230, network interface hardware 240, a screen 110, a microphone 112, a speaker 114, and a front-view camera 116. In some embodiments, the one or more processors 202, and the one or more memory modules 204 may be provided in a single integrated circuit (e.g., a system on a chip). In some embodiments, the one or more processors 202, and the one or more memory modules 204 may be provided as separate integrated circuits.

Each of the one or more processors 202 is configured to communicate with electrically coupled components, and may be configured as any commercially available or customized processor suitable for the particular applications that the mobile robot 100 is designed to operate. Each of the one or more processors 202 may be any device capable of executing machine readable instructions. Accordingly, each of the one or more processors 202 may be a controller, an integrated circuit, a microchip, a computer, or any other computing device. The one or more processors 202 are coupled to a communication path 206 that provides signal interconnectivity between various modules of the mobile robot 100. The communication path 206 may communicatively couple any number of processors with one another, and allow the modules coupled to the communication path 206 to operate in a distributed computing environment. Specifically, each of the modules may operate as a node that may send and/or receive data. As used herein, the term “communicatively coupled” means that coupled components are capable of exchanging data signals with one another such as, for example, electrical signals via conductive medium, electromagnetic signals via air, optical signals via optical waveguides, and the like.

Accordingly, the communication path 206 may be formed from any medium that is capable of transmitting a signal such as, for example, conductive wires, conductive traces, optical waveguides, or the like. Moreover, the communication path 206 may be formed from a combination of mediums capable of transmitting signals. In one embodiment, the communication path 206 comprises a combination of conductive traces, conductive wires, connectors, and buses that cooperate to permit the transmission of electrical data signals to components such as processors, memories, sensors, input devices, output devices, and communication devices. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium.

The one or more memory modules 204 may be coupled to the communication path 206. The one or more memory modules 204 may include a volatile and/or nonvolatile computer-readable storage medium, such as RAM, ROM, flash memories, hard drives, or any medium capable of storing machine readable instructions such that the machine readable instructions can be accessed by the one or more processors 202. The machine readable instructions may comprise logic or algorithm(s) written in any programming language of any generation (e.g., 1GL, 2GL, 3GL, 4GL, or 5GL) such as, for example, machine language that may be directly executed by the processor, or assembly language, user-oriented programming (OOP), scripting languages, microcode, etc., that may be compiled or assembled into machine readable instructions and stored on the one or more memory modules 204. Alternatively, the machine readable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components.

The one or more memory modules 204 may be configured to store one or more modules, each of which includes the set of instructions that, when executed by the one or more processors 202, cause the mobile robot 100 to carry out the functionality of the module described herein. For example, the one or more memory modules 204 may be configured to store a robot operating module, including, but not limited to, the set of instructions that, when executed by the one or more processors 202, cause the mobile robot 100 to carry out general robot operations.

The mobile robot 100 may include the satellite antenna 220 coupled to the communication path 206 such that the communication path 206 communicatively couples the satellite antenna 220 to other modules of the mobile robot 100. The satellite antenna 220 is configured to receive signals from global positioning system satellites. Specifically, in one embodiment, the satellite antenna 220 includes one or more conductive elements that interact with electromagnetic signals transmitted by global positioning system satellites. The received signal is transformed into a data signal indicative of the location (e.g., latitude and longitude) of the satellite antenna 220 or a user positioned near the satellite antenna 220, by the one or more processors 202. In some embodiments, the mobile robot 100 may not include the satellite antenna 220.

The driving unit 230 may comprise actuators, associated drive electronics to control the actuators, and any other external components that may be present in the mobile robot 100. The driving unit 230 may be configured to receive control signals from the one or more processors 202 and to operate the mobile robot 100 accordingly. The operating parameters and/or gains for the driving unit 230 may be stored in the one or more memory modules 204.

The mobile robot 100 includes the network interface hardware 240 for communicatively coupling the mobile robot 100 with the cloud server 140 or the robot control system 200. The network interface hardware 240 may be coupled to the communication path 206 and may be configured as a wireless communications circuit such that the mobile robot 100 may communicate with external systems and devices. The network interface hardware 240 may include a communication transceiver for sending and/or receiving data according to any wireless communication standard. For example, the network interface hardware 240 may include a chipset (e.g., antenna, processors, machine readable instructions, etc.) to communicate over wireless computer networks such as, for example, wireless fidelity (Wi-Fi), WiMax, Bluetooth, IrDA, Wireless USB, Z-Wave, ZigBee, or the like. In some embodiments, the network interface hardware 240 includes a Bluetooth transceiver that enables the mobile robot 100 to exchange information with the cloud server 140 or the robot control system 200.

The mobile robot 100 may include the screen 110 coupled to the communication path 206 such that the communication path 206 communicatively couples the screen 110 to other modules of the mobile robot 100. The screen 110 may display information about a task currently implemented by the mobile robot 100, for example, delivering items, picking up items, and the like.

The mobile robot 100 includes the microphone 112 coupled to the communication path 206 such that the communication path 206 communicatively couples the microphone 112 to other modules of the mobile robot 100. The microphone 112 may be configured for receiving user voice commands and/or other inputs to the mobile robot 100. The microphone 112 transforms acoustic vibrations received by the microphone 112 into a speech input signal.

The mobile robot 100 includes the speaker 114 coupled to the communication path 206 such that the communication path 206 communicatively couples the speaker 114 to other modules of the mobile robot 100. The speaker 114 transforms data signals into audible mechanical vibrations. The speaker 114 outputs audible sound such that a user proximate to the mobile robot 100 may interact with the mobile robot 100.

The mobile robot 100 includes a front-view camera 116. The front-view camera 116 may include, but not limited to, RGBD sensor, or depth sensors configured to obtain depth information of a target area. The front-view camera 116 may have any suitable resolution and may be configured to detect radiation in any desirable wavelength band, such as an ultraviolet wavelength band, a near-ultraviolet wavelength band, a visible light wavelength band, a near infrared wavelength band, or an infrared wavelength band.

The cloud server 140 includes a controller 260 that includes one or more processors 262 and one or more memory modules 264, and network interface hardware 268. The one or more processors 262, one or more memory modules 264, and the network interface hardware 268 may be components similar to the one or more processors 202, one or more memory modules 204, and the network interface hardware 240, as described above.

FIG. 3 depicts a flowchart of the mapping process of AR tags during a mapping mode, according to one or more embodiments shown and described herein.

In embodiments, during the mapping mode, the mobile robot 100 navigates in an indoor environment, and collects pose data of AR tags in the indoor environment. While AR tags are described in the present disclosure, tags that have similar features as AR tags may be used. The mobile robot 100 obtains an image 300 including one or more AR tags using the imaging sensor such as the front-view camera 116 that is an RGBD camera. The image 300 includes RGB data 302 and depth data 304.

In step 310, the mobile robot 100 collects RGB data 302 out of the image 300 captured by the imaging sensor. RGB data 302 is a color representation method that uses the primary colors red, green, and blue (RGB) to create images.

In step 320, the mobile robot 100 determines whether one or more tags such as AR tags are detected in the image based on the RGB data 302. For example, the controller of the mobile robot 100 performs an AR tag detection algorithm or an image processing on the RGB data 302 of the image to determine whether one or more tags are detected in the image 300. If no tag is detected, the process proceeds to step 360, and the mobile robot 100 continues to navigate and capture images until one or more tags are detected in the captured images.

In step 330, if one or more tags are detected in the image 300, the mobile robot 100 applies depth fusion to the image 300 to obtain pose data of the one or more tags in the image 300 or a camera frame. Depth fusion is a process that combines depth maps from multiple perspectives to create a 3D model of a scene. Specifically, once a tag is identified in the image 300, the depth data 304 of the image 300 is utilized to obtain pose data of the one or more tags in the image 300. The pose data of the one or more tags represents the position and the orientation of the one or more tags, each usually in three dimensions.

In step 340, the mobile robot 100 performs mapping backend with regard to the pose data 306 of the robot in a map frame and the pose data of the tag in a camera frame such as the image 300 to compute pose data of the tag in the map frame. Mapping backend is the process of defining how data from different sources should be transformed and matched to corresponding fields in a target system.

In step 350, the mobile robot 100 uploads the computed pose data of the tag in the map frame to the cloud server 140. The cloud server 140 updates the map for the indoor environment by including the pose data of the tag in the map frame received from the mobile robot 100.

FIG. 4 depicts a flowchart of the AR tag detection and localization process during a navigation mode, according to one or more embodiments shown and described herein.

During the navigation mode, the mobile robot 100 localizes itself by detecting AR tags disposed in an indoor environment. By referring to FIG. 4, in step 410, the mobile robot 100 collects an image 400 using the front-view camera 116 such as the front-view camera 116 while navigating in the indoor environment.

In step 420, the mobile robot 100 determines whether any tags are detected in the captured image 400. For example, the controller of the mobile robot 100 performs an AR tag detection algorithm or an image processing on the image to determine whether any tag is detected in the image 400. If no tag is detected, the process proceeds to step 422, and the mobile robot 100 continues to navigate and capture images until one or more tags are detected in the captured images. If any tag is detected, the process proceeds to step 430,

In step 430, the mobile robot 100 determines whether a single tag or two or more tags are detected in the image 400. If a single tag is detected in the image, the process proceeds to step 440. If two or more tags are detected in the image, the process proceeds to step 450.

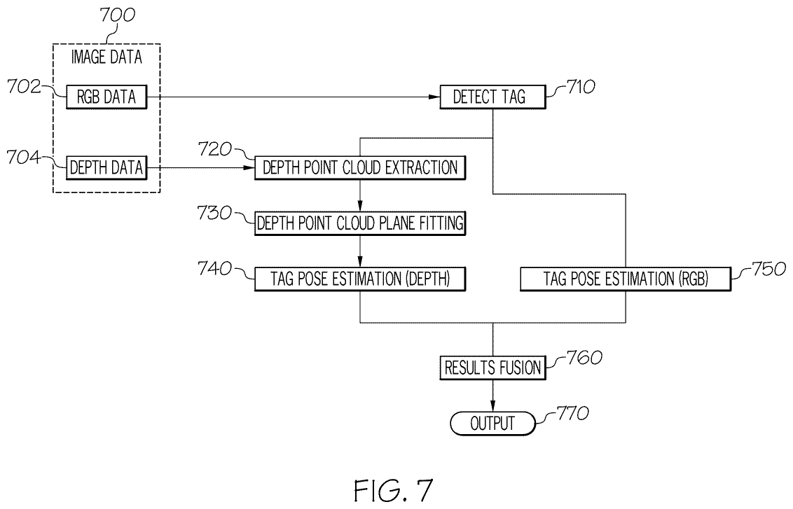

In step 440, the mobile robot 100 applies a first tag detection algorithm such as a depth fusion detection algorithm to the image. The application of the depth fusion detection algorithm will be described in detail below with reference to FIG. 7.

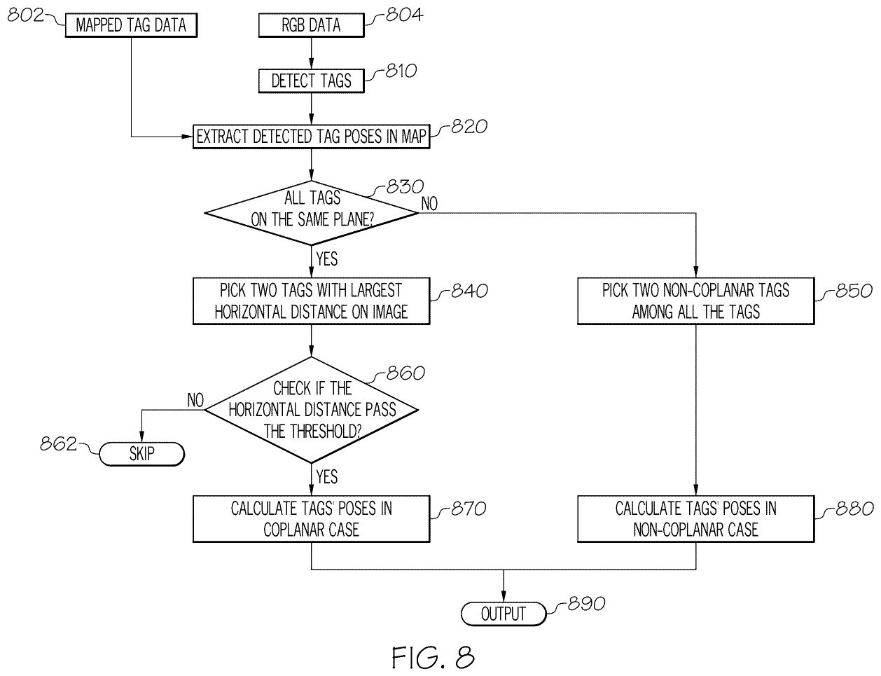

In step 450, the mobile robot 100 applies a second tag detection algorithm such as a tag bundle detection algorithm to the image to obtain pose data of the two or more tags in the image. The application of the tag bundle detection algorithm will be described in detail below with reference to FIG. 8.

In step 460, the mobile robot 100 obtains pose data of the single tag in the image based on application of the depth fusion detection algorithm if only one tag is detected in the image, or obtains pose data of two or more tags in the image based on application of the tag bundle detection algorithm if two or more tags are detected in the image.

In step 470, the mobile robot 100 downloads pose data of the tag in a map frame or a map from the cloud server 140 and performs AR tag localization with respect to the pose data of the tag in the map frame and the pose data of the detected one or more tags in the image.

In step 480, the mobile robot 100 determines the pose data of the robot in the map frame based on the comparison of the pose data of the single tag in the image and the pose data of the tag in the map frame when a single tag is detected in step 430. The mobile robot 100 determines pose data of the robot in the map frame based on the comparison of the pose data of the two or more tags in the image and the pose data of the two or more tags in the map frame when two or more tags are detected in step 430. Once the mobile robot 100 determines the pose data of the robot in the map, the mobile robot 100 operates the one or more motors to autonomously navigate the mobile robot based on the pose data of the mobile robot 100 in the map frame.

FIG. 7 depicts a flow chart of depth fusion tag detection, according to one or more embodiments shown and described herein.

In embodiments, the depth fusion tag detection is implemented when a single tag is detected in a captured image. By referring to FIG. 7, in step 710, the mobile robot 100 detects a single tag such as an AR tag in the image 700 based on the RGB data 702. For example, the controller of the mobile robot 100 performs an AR tag detection algorithm or an image processing on the image to detect a single tag in the image 700. As discussed above, if two or more tags are detected in the image, the mobile robot 100 performs the tag bundle detection algorithm that is described with reference to FIG. 8. After a single tag is detected, the process proceeds to steps 720 through 740 and step 750 in parallel.

In steps 720 through 740, the mobile robot 100 estimates first pose data of the single tag in the image based on depth data of the image.

In step 720, the mobile robot 100 extracts depth points by selecting, from depth data 704 of the image 700, depth points in a convex hull generated by four corners of the single tag in the depth data 704.

In step 730, the mobile robot 100 identifies a plane on which the single tag lies in a 3D space by plane fitting through the extracted depth points.

In step 740, the mobile robot 100 calculates coordinates of the four corners in the 3D space through reprojection from the corner points in the image to the plane identified in step 730. The mobile robot 100 estimates the first pose data of the single tag in the image based on the coordinates of the four corners in the 3D space. Specifically, once the coordinates of the four corners in the 3D space is calculated, rigid transformation is calculated to obtain the first pose data of the single tag based on the depth data.

In step 750, the mobile robot 100 estimates second pose data of the single tag in the image based on RGB data of the image. For example, the mobile robot 100 may calculate one or two possible pose data of the single tag based on RGB data 702 through a pose estimation algorithm.

In step 760, the mobile robot 100 obtains the pose data of the single tag in the image through graph optimization fusion of the first pose data in the image and the second pose data in the image. The graph optimization fusion is a process that analyzes and improves the computational graph of a network.

In step 770, the mobile robot 100 proceeds to calculate the pose data of the mobile robot 100 in the map based on the pose data of the single tag in the image, as described in steps 460 through 480 above.

FIG. 8 depicts a flow chart of tag bundle detection, according to one or more embodiments shown and described herein.

In embodiments, the tag bundle detection is implemented when two or more tags are detected in a captured image. By referring to FIG. 8, in step 810, the mobile robot 100 detects two or more tags such as AR tags in the image based on the RGB data 804. For example, the controller of the mobile robot 100 performs an AR tag detection algorithm or an image processing on the image to detect the two or more tags in the image. As discussed above, if a single tag is detected in the image, the mobile robot 100 performs the depth fusion tag detection algorithm that is described with reference to FIG. 7.

In step 820, the mobile robot 100 extracts pose data of the detected two or more tags in a map from the mapped tag data 802. The mapped tag data 802 is published through a robot operating system (ROS) topic and the information of detected tags on image is extracted through this topic. The ROS topic is a communication channel that allows different nodes to exchange data with each other by publishing and subscribing to messages on that topic.

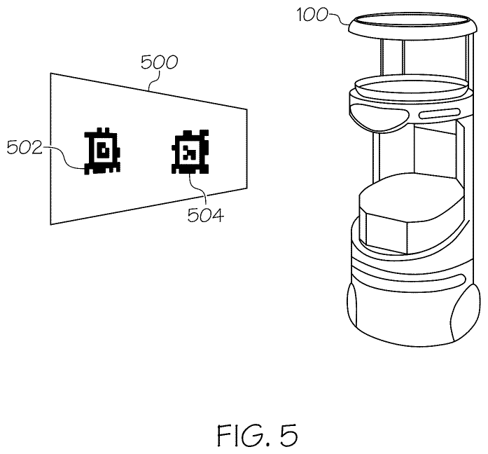

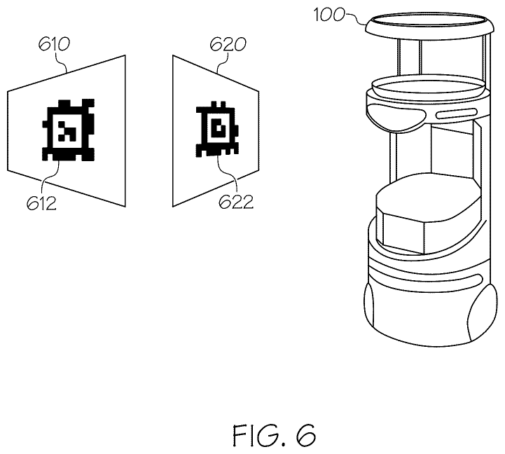

In step 830, the mobile robot 100 determines whether the detected two or more tags are on the same plane based on the pose data. Specifically, the mobile robot 100 may calculate the 3D coordinates of the corners of all detected tags in the map frame and performs data analysis such as principal component analysis (PCA) to determine whether the two or more tags are on the same plane or not. FIG. 5 depicts a scenario when the mobile robot localizes itself by detecting and analyzing coplanar tags, according to one or more embodiments shown and described herein. In FIG. 5, the AR tag 502 and the AR tag 504 are on the same plane 500. FIG. 6 depicts a scenario when the mobile robot localizes itself by detecting and analyzing tags on different planes, according to one or more embodiments shown and described herein. In FIG. 6, the AR tag 612 and the AR tag 622 are on different planes 610 and 620, respectively. If the detected two or more tags are on the same plane, the process proceeds to step 840. If the detected two or more tags are not on the same plane, the process proceeds to step 850.

In step 840, the mobile robot 100 selects two tags with a largest horizontal distance on the image among the two or more tags that are on the same plane.

In step 860, the mobile robot 100 determines whether the largest horizontal distance between the selected two tags is greater than a predetermined threshold. If the largest horizontal distance between the selected two tags is not greater than a predetermined threshold, the process proceeds to step 862 and the mobile robot 100 stops calculating the pose data of the tags in the image.

In step 870, if the largest horizontal distance between the selected two tags is greater than a predetermined threshold, the mobile robot 100 calculates pose data of the detected two or more tags in the image based on the comparison of 3D coordinates of the corners of the two or more tags in the map and the 2D pixel coordinates of the corners of the two or more tags in the image. The mobile robot 100 may calculate the homography matrix for solving the PnP problem with respect to the 3D coordinates of the corners of the two or more tags in the map and corresponding projected 2D pixel coordinates of the corners of the two or more tags on image. The pose data of the two or more tags in the image is obtained by decomposing the homography matrix.

In step 850, the mobile robot 100 selects two non-coplanar tags among the detected two or more tags in the image. If all the detected tags are not on the same plane, the mobile robot 100 selects two non-coplanar tags among all of the detect tags in order to confirm whether the selected two tags are on the same plane or not. PCA analysis may be implemented to determine if all corner points of the selected two tags are on the same plane or not.

In step 880, the mobile robot 100 calculates pose data of the selected two non-coplanar tags in the image based on a comparison of 3D coordinates of corners of the selected two non-coplanar tags in the map frame and 2D pixel coordinates of corners of the selected two non-coplanar in the image. Specifically, efficient perspective-n-point (EPnP) algorithm may be implemented for solving PnP problem with respect to the 3D coordinates of the corners of the two or more tags in the map frame and corresponding projected 2D pixel coordinates of the corners of the two or more tags in the image. The tag pose in the camera frame is obtained by decomposing the transformation matrix between the map frame and the image frame.

In embodiments, the mobile robot operates in two modes: a navigation mode and a mapping mode. During the mapping mode, the mobile robot moves around in an indoor environment, detects tags, computes the pose data of the detected tags in a map frame, and uploads the pose data of the detected tags in the map frame to a cloud server. During the navigation mode, the mobile robot moves around in an indoor environment, detects tags, calculates the pose data of the detected tags in a map frame, calculates the pose data of the mobile robot in the map frame, and navigates in the indoor environment based on the pose data of the robot in the map frame.

The system of the present disclosure provides the follow technical advantages: enhanced robotic localization, improvement in mapping accuracy, infrastructure independence, autonomous operation, flexibility, and robustness. First, the system improves robotic localization in indoor environments. Specifically, the present system more accurately localizes the mobile robot in indoor environments by calculating the pose data of the mobile in a map frame with reference to pose data of detected tags in the map frame. Second, the present system enhances mapping accuracy. Specifically, the present system ensures precise calculations of pose data of tags in the map frame with depth fusion based method, which ensures accurate and reliable mapping processes. Third, the present system provides infrastructure independence. Specifically, the present system eliminates dependence on any external localization infrastructure, such as external positioning systems. Mobile robots can accurate localize themselves just with analysis of detected tags. In addition, the present system allows mobile robots to navigate reliably in challenging environments, such as environments without good Lidar sensors or other visual features. Fourth, the present system provides autonomous operation. For example, the present system autonomously refines the pose data of the mobile robots when the mobile robots perceive AR tags while the mobile robots are in the navigation mode. Fifth, the present system provides flexibility to place AR tags in any orientation or location as long as they are within the field of view of cameras of mobile robots. In this regard, the present system simplifies the installation of AR tags in the environment which is unprecedented. Sixth, the present system effectively eliminates ambiguity issue caused by projection of 2D tag to 2D image. Thus, the present system increases the overall positioning precision of mobile robots in the navigation mode.

According to one or more embodiments of the present disclosure, the present system provides the following technical features: dual-mode operation, creative synergy, robust robot pose estimation, and adaptiveness to different tag placement settings.

Regarding the dual-mode operation, the present system splits the architecture into two parts: AR tag mapping occurs when the mobile robot is in the mapping mode, while AR tag-based localization is employed when the mobile robot is in the navigation mode. The mobile robot utilizes both mapped AR tags and detected AR tags to correct the pose data of the mobile robot in the navigation mode to prevent mislocalization of the mobile robot. These features distinguish the present system over conventional approaches, representing a leap in the field of robotic navigation and mapping.

Regarding the creative synergy, the present system creatively synergizes various elements, including the depth fusion detection algorithm and tag bundle detection algorithm, which can utilize the advantages of both methods while compensating disadvantages. The present system provides advancement over existing technologies by uniquely integrating these algorithms, resulting in a solution that stands out in terms of effectiveness and innovation.

Regarding the robust robot pose estimation, the present system provides stable robot pose estimation when the robot is in the navigation mode. The present system also overcomes the ambiguity issue in planar target pose estimation by utilizing multiple tags simultaneously or depth data from a single tag. In addition, the present system guarantees the reliability of detected AR tag poses by utilizing systematic sanity check metric.

Regarding the adaptiveness to different tag placement settings, the present system handles different tag placement settings: either tags are on the same plane or not, which provides major improvements in position accuracy compared to traditional tag-bundle based pose estimation.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

It is noted that the singular forms “a” and “an” are intended to include the plural forms as well, unless the context clearly indicates otherwise. Although the terms first, second, and the like may be used herein to describe various elements, components, steps and/or operations, these terms are only used to distinguish one element, component, step or operation from another element, component, step, or operation.

The recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A robot comprising:
an imaging sensor;
one or more motors;
a controller programmed to:
during a navigation mode:
determine whether two or more tags are detected in an image captured by the imaging sensor;
in response to determining that a single tag is detected in the image, apply a first tag detection algorithm to the image to obtain pose data of the single tag in the image;
in response to determining that two or more tags are detected in the image, apply a second tag detection algorithm to the image to obtain pose data of the two or more tags in the image;
obtain pose data of the single tag in a map frame or pose data of the two or more tags in the map frame;
determine pose data of the robot in the map frame based on a comparison of the pose data of the single tag in the image and the pose data of the tag in the map frame, or determine pose data of the robot in the map frame based on a comparison of the pose data of the two or more tags in the image and the pose data of the two or more tags in the map frame; and
operate the one or more motors to autonomously navigate the robot based on the pose data of the robot in the map frame.

2. The robot of claim 1, wherein applying the first tag detection algorithm to the image comprises:
estimating first pose data of the single tag in the image based on depth data of the image;
estimating second pose data of the single tag in the image based on RGB data of the image; and
obtaining the pose data of the single tag in the image through graph optimization fusion of the first pose data and the second pose data.

3. The robot of claim 2, wherein estimating first pose data of the single tag based on depth data of the image comprises:
selecting, from depth data of the image, depth points in a convex hull generated by four corners of the single tag in the depth data;
identifying a plane on which the single tag lies in a 3D space by plane fitting through the extracted depth points;
calculating coordinates of the four corners in the 3D space through reprojection from the corner points in the image to the identified plane; and
estimating the first pose data of the single tag in the image based on the coordinates of the four corners in the 3D space.

4. The robot of claim 1, wherein applying the second tag detection algorithm to the image comprises:
extracting pose data of the detected two or more tags in the map frame;
determining whether the detected two or more tags are on a same plane in the map frame based on the pose data;
in response to determining that the detected two or more tags are on the same plane in the map frame, selecting two tags with a largest horizontal distance on the image among the two or more tags;
determining whether the largest horizontal distance between the selected two tags is greater than a predetermined threshold; and
in response to determining that the largest horizontal distance between the selected two tags is greater than the predetermined threshold, calculating pose data of the detected two or more tags in the image based on a comparison of 3D coordinates of corners of the two or more tags in the map frame and 2D pixel coordinates of corners of the two or more tags in the image.

5. The robot of claim 4, wherein the controller is further programmed to:
in response to determining that all the detected two or more tags are not on the same plane, select two non-coplanar tags among the detected two or more tags; and
calculate pose data of the selected two non-coplanar tags in the image based on a comparison of 3D coordinates of corners of the selected two non-coplanar tags in the map frame and 2D pixel coordinates of corners of the selected two non-coplanar in the image.

6. The robot of claim 1, wherein the first tag detection algorithm is a depth fusion detection algorithm, and the second tag detection algorithm is a tag bundle detection algorithm.

7. The robot of claim 1, wherein the controller is further programmed to:
during a mapping mode:
obtain an image including one or more tags using the imaging sensor;
apply depth fusion to the image to obtain pose data of the one or more tags in the image; and
compute pose data of the one or more tags in the map frame based on pose data of the robot in the map frame and the pose data of the one or more tags in the image.

8. The robot of claim 7, wherein the controller is further programmed to:
during the mapping mode, upload the pose data of the tag in the map frame to a cloud server.

9. The robot of claim 1 wherein the imaging sensor is a RGBD camera.

10. A method for controlling a robot, the method comprising:
during a navigation mode:
determining whether two or more tags are detected in an image captured by an imaging sensor;
in response to determining that a single tag is detected in the image, applying a first tag detection algorithm to the image to obtain pose data of the single tag in the image;
in response to determining that two or more tags are detected in the image, applying a second tag detection algorithm to the image to obtain pose data of the two or more tags in the image;
obtaining pose data of the single tag in a map frame or pose data of the two or more tags in the map frame;
determining pose data of the robot in the map frame based on a comparison of the pose data of the single tag in the image and the pose data of the tag in the map frame, or determining pose data of the robot in the map frame based on a comparison of the pose data of the two or more tags in the image and the pose data of the two or more tags in the map frame; and
operating one or more motors of the robot to autonomously navigate the robot based on the pose data of the robot in the map frame.

11. The method of claim 10, wherein applying the first tag detection algorithm to the image comprises:
estimating first pose data of the single tag in the image based on depth data of the image;
estimating second pose data of the single tag in the image based on RGB data of the image; and
obtaining the pose data of the single tag in the image through graph optimization fusion of the first pose data and the second pose data.

12. The method of claim 11, wherein estimating first pose data of the single tag based on depth data of the image comprises:
selecting, from depth data of the image, depth points in a convex hull generated by four corners of the single tag in the depth data;
identifying a plane on which the single tag lies in a 3D space by plane fitting through the extracted depth points;
calculating coordinates of the four corners in the 3D space through reprojection from the corner points in the image to the identified plane; and
estimating the first pose data of the single tag in the image based on the coordinates of the four corners in the 3D space.

13. The method of claim 10, wherein applying the second tag detection algorithm to the image comprises:
extracting pose data of the detected two or more tags in the map frame;
determining whether the detected two or more tags are on a same plane in the map frame based on the pose data;
in response to determining that the detected two or more tags are on the same plane in the map frame, selecting two tags with a largest horizontal distance on the image among the two or more tags;
determining whether the largest horizontal distance between the selected two tags is greater than a predetermined threshold; and
in response to determining that the largest horizontal distance between the selected two tags is greater than the predetermined threshold, calculating pose data of the detected two or more tags in the image based on a comparison of 3D coordinates of corners of the two or more tags in the map frame and 2D pixel coordinates of corners of the two or more tags in the image.

14. The method of claim 13, further comprising:
in response to determining that all the detected two or more tags are not on the same plane, selecting two non-coplanar tags among the detected two or more tags; and
calculating pose data of the selected two non-coplanar tags in the image based on a comparison of 3D coordinates of corners of the selected two non-coplanar tags in the map frame and 2D pixel coordinates of corners of the selected two non-coplanar in the image.

15. The method of claim 10, wherein the first tag detection algorithm is a depth fusion detection algorithm, and the second tag detection algorithm is a tag bundle detection algorithm.

16. The method of claim 10, further comprising:
during a mapping mode:
obtaining an image including one or more tags using the imaging sensor;
applying depth fusion to the image to obtain pose data of the one or more tags in the image; and
computing pose data of the one or more tags in the map frame based on pose data of the robot in the map frame and the pose data of the one or more tags in the image.

17. The method of claim 16, further comprising:
during the mapping mode, uploading the pose data of the tag in the map frame to a cloud server.

18. A non-transitory computer readable medium storing instructions, when executed by a processor, that instruct a robot to perform:
during a navigation mode:
determining whether two or more tags are detected in an image captured by an imaging sensor;
in response to determining that a single tag is detected in the image, applying a first tag detection algorithm to the image to obtain pose data of the single tag in the image;
in response to determining that two or more tags are detected in the image, applying a second tag detection algorithm to the image to obtain pose data of the two or more tags in the image;
obtaining pose data of the single tag in a map frame or pose data of the two or more tags in the map frame;
determining pose data of the robot in the map frame based on a comparison of the pose data of the single tag in the image and the pose data of the tag in the map frame, or determining pose data of the robot in the map frame based on a comparison of the pose data of the two or more tags in the image and the pose data of the two or more tags in the map frame; and
operating one or more motors of the robot to autonomously navigate the robot based on the pose data of the robot in the map frame.

19. The non-transitory computer readable medium of claim 18, wherein applying the first tag detection algorithm to the image comprises:
estimating first pose data of the single tag in the image based on depth data of the image;
estimating second pose data of the single tag in the image based on RGB data of the image; and
obtaining the pose data of the single tag in the image through graph optimization fusion of the first pose data and the second pose data.

20. The non-transitory computer readable medium of claim 19, wherein estimating first pose data of the single tag based on depth data of the image comprises:
selecting, from depth data of the image, depth points in a convex hull generated by four corners of the single tag in the depth data;
identifying a plane on which the single tag lies in a 3D space by plane fitting through the extracted depth points;
calculating coordinates of the four corners in the 3D space through reprojection from the corner points in the image to the identified plane; and
estimating the first pose data of the single tag in the image based on the coordinates of the four corners in the 3D space.
